(19) United States
(12) Patent Application Publication
(10) Pub. No.: US 2011/0021197 A1
(43) Pub. Date: Jan. 27, 2011

(54) APPARATUS AND METHOD FOR FACILITATING TRANSFER TO A SECONDARY CELL

(75) Inventor: Francis M. Ngai, Louisville, CO (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/508,827

(22) Filed: Jul. 24, 2009

(51) Int. Cl. H04W 36/00; H04M 1/00; H04B 7/00

(52) U.S. Cl. 455/436; 455/550.1; 455/522

(57) ABSTRACT

A method and apparatus facilitating access to a communication session for a client is provided. The method may comprise obtaining, by a wireless communications device (WCD), reverse link transmit power to a primary cell, detecting if the transmit power to the primary cell exceeds a first threshold, locating one or more secondary cells when the detected transmit power exceeds the first threshold, obtaining reverse link transmit power to the one or more located secondary cells, and initiating a session transfer to a secondary cell when the secondary cell estimated transmit power is less than the transmit power to the primary cell.

### BACKGROUND

1. Field

The present application relates generally to wireless communications, and more specifically to methods and systems for facilitating a transfer by a wireless communications device to a secondary cell.

2. Background

Wireless communication systems are widely deployed across multiple countries to provide various types of communication (e.g., voice, data, multimedia services, etc.) to multiple users. Examples of such communication systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

In addition to mobile phone networks currently in place, a new class of small base stations, generally known as access point base stations, or, alternatively, Home Node B (HNB) or femtocells, has emerged. Generally, handing-in and/or handing-out of such femtocells have been triggered by measuring forward link signal strength from a prospective femtocell. Such transfer processes, triggered by forward link metrics, do not provide any indication as to whether a transfer (e.g. hand-in and/or hand-out) would provide any advantages to a wireless communications device with respect to reverse link communications. Therefore, needless transfer into and out of a femtocell may be processed, leading to delays and wasted energy. Thus, improved apparatus and methods for facilitating hand-in and/or hand-out by a wireless communications device to a secondary cell (e.g. femtocell) are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with making calls from a wireless communications device in a source country outside of a home country. According to one aspect, a method for facilitating a session transfer by a wireless communications device to a secondary cell is provided. The method can comprise obtaining, by a wireless communications device (WCD), reverse link transmit power to a primary cell, detecting, by the WCD, if the transmit power to the primary cell exceeds a first threshold, locating one or more secondary cells when the detected transmit power exceeds the first threshold, obtaining, by the WCD, reverse link transmit power to the one or more located secondary cells, and initiating, by the WCD, a session transfer to a secondary cell when the secondary cell estimated transmit power is less than the transmit power to the primary cell by a second threshold.

Another aspect relates to at least one processor configured to facilitate a session transfer by a wireless communications device to a secondary cell. The at least one processor can comprise a first module for obtaining, by a wireless communications device (WCD), reverse link transmit power to a primary cell, a second module for detecting, by the WCD, if the transmit power to the primary cell exceeds a first threshold, a third module for locating one or more secondary cells when the detected transmit power exceeds the first threshold, a fourth module for obtaining, by the WCD, reverse link transmit power to the one or more located secondary cells, and a fifth module for initiating, by the WCD, a session transfer to a secondary cell when the secondary cell estimated transmit power is less than the transmit power to the primary cell by a second threshold.

Still another aspect relates to a computer program product comprising a computer-readable medium. The computer-readable medium can include a first set of codes for causing a computer to obtain, by a wireless communications device (WCD), reverse link transmit power to a primary cell, a second set of codes for causing the computer to detect, by the WCD, if the transmit power to the primary cell exceeds a first threshold, a third set of codes for causing the computer to locate one or more secondary cells when the detected transmit power exceeds the first threshold, a fourth set of codes for causing the computer to obtain, by the WCD, reverse link transmit power to the one or more located secondary cells, and a fifth set of codes for causing the computer to initiate, by the WCD, a session transfer to a secondary cell when the secondary cell estimated transmit power is less than the transmit power to the primary cell by a second threshold.

Yet another aspect relates to an apparatus. The apparatus can include means for obtaining, by a wireless communications device (WCD), reverse link transmit power to a primary cell, means for detecting, by the WCD, if the transmit power to the primary cell exceeds a first threshold, means for locating one or more secondary cells when the detected transmit power exceeds the first threshold, means for obtaining, by the WCD, reverse link transmit power to the one or more located secondary cells, and means for initiating, by the WCD, a session transfer to a secondary cell when the secondary cell estimated transmit power is less than the transmit power to the primary cell by a second threshold.

Another aspect relates to an apparatus. The apparatus can include a cell reselection module operable for: obtaining reverse link transmit power to a primary cell, and detecting if the transmit power to the primary cell exceeds a first threshold, a receiver operable for locating one or more secondary cells when the detected transmit power exceeds the first threshold, and wherein the cell reselection module is further operable for: obtaining, by the WCD, reverse link transmit power to the one or more located secondary cells, and initiating, by the WCD, a session transfer to a secondary cell when the secondary cell estimated transmit power is less than the transmit power to the primary cell by a second threshold.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a block diagram of an exemplary communication system that can facilitate a transfer by a wireless communications device to a secondary cell;

FIG. 2 depicts exemplary graphs for selecting one or more transfer thresholds for facilitating a transfer by a wireless communications device to a secondary cell;

FIG. 3 depicts an exemplary method for facilitating a transfer by a wireless communications device to a secondary cell;

FIG. 4 depicts a block diagram of an exemplary wireless communications device that can facilitate a transfer to a secondary cell;

FIG. 5 depicts a block diagram of an exemplary communication system that can facilitate a transfer by a wireless communications device to a secondary cell;

FIG. 6 illustrates an exemplary multiple access wireless communication system according to an aspect;

FIG. 7 depicts a block diagram of an exemplary communication system.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Generally, a wireless communications device (WCD) may hand-in to a secondary cell (e.g. femtocell, etc.) for multiple reasons, such as but not limited to, increased forward link signal strength. Additionally, or in the alternative, a WCD may obtain improved reverse link communications by handing-in to a secondary cell (e.g. femtocell, etc.). Furthermore, although the following description generally may make reference to a hand-in from a macro cell to a femtocell, one of ordinary skill in the art would understand the claimed subject matter may be equally applicable to a hand-out from a femtocell to a macro cell.

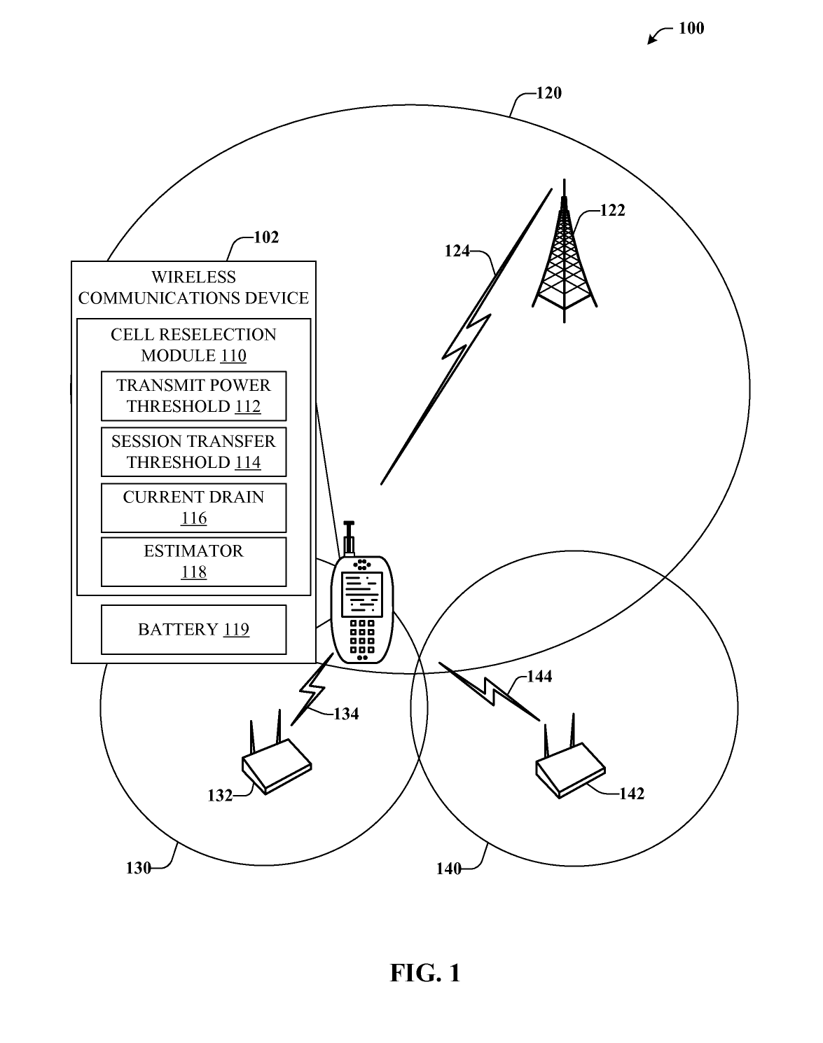

With reference now to FIG. 1, exemplary system 100 that can facilitate a transfer by a wireless communications device to a secondary cell is depicted. Generally, system 100 can include wireless communications device (WCD) 102, base station 122, and one or more femto base stations 132 and/or 142, otherwise referred to as femtocells. In one aspect, base station 122 may interact with WCD 102 through forward and reverse link communications 124. Further, base station 122 may provide service of a coverage area 120. In one aspect, femtocell 132 may provide service over a coverage area 130, while femtocell 142 may provide service over a coverage area 140. Furthermore, the one or more depicted femtocells (132, 142) may provide candidate communication sessions 134, 144 for WCD 102.

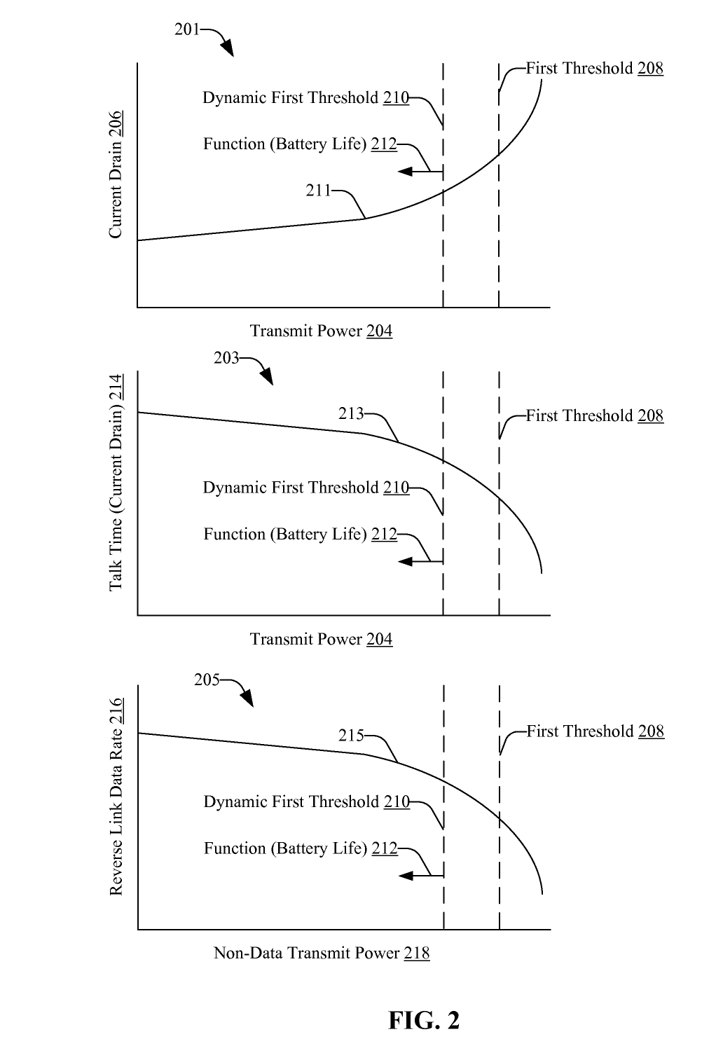

In one aspect, WCD 102 may include cell reselection module 110. In such an aspect, cell reselection module 110 may include transmit power threshold module 112, session transfer threshold module 114, current drain module 116 and estimator 118. In one aspect, transmit power threshold module 112 may be operable to determine when WCD 102 should locate possible candidate secondary cells 132, 142 for hand-in. Further, in one aspect, session transfer threshold module 114 may be operable to determine whether a candidate secondary cell 132, 142 is sufficiently superior to primary cell 122 to merit performing a hand-in to the secondary cell. Further discussion with respect to transmit power threshold module 112 and session transfer threshold module 114 is presented with reference to FIGS. 2, 3, and 4. Still further, current drain module 116, may be operable to monitor WCD 102 usage of current or charge or power of battery 119 by different components of WCD 102. For example, current drain module 116 may monitor power needed for reverse link transmissions from WCD 102 to base station 122. Additionally, cell reselection module 118 may include an estimator 118 having logic to estimate possible reverse link transmission power needed to communicate with femtocells 132, 142.

In operation, as reverse link transmission power needed to maintain communication with base station 122 increases, power available for other activities associated with WCD 102 decreases. For example, increased transmission power reduces battery life and therefore reduces available talk time. Further, for example, increased transmission power reduces available “headroom” for data transmission and therefore reduces possible data rate transmissions. As used with respect to the described aspects, “headroom” may be defines as a maximum possible transmission power for a WCD less transmission power used for pilot and/or fundamental channel communications. In one aspect, transmit power threshold 112 may be operable to select one or more static or dynamic thresholds to apply to trigger WCD 102 to start to look for available secondary cells. For example, when reverse link transmission power to base station 122 increases above the defined threshold, WCD may look for candidate secondary cells, such as femtocells 132 and 142 depicted in FIG. 1. WCD 102 may include an estimator 118 having logic to estimate possible reverse link transmission power needed to communicate with the located femtocells 132, 142 and may use session transfer module 114 to determine whether any estimated transmission powers are sufficiently lower than the transmission power to base station 122 to merit hand-in to the candidate femtocell 132, 144. For example, as depicted in FIG. 1, assuming WCD 102 is within candidate femtocell 132 coverage area 130 and reverse link communication 134 is sufficiently superior to reverse link communication 124, WCD 102 may hand-in to femtocell 132 and receive service accordingly.

In some aspects, for example, a secondary cell may be deemed to be sufficiently superior to the primary cell, for purposes of handover, based on a relative difference between the estimated transmit power to the secondary cell and the actual transmit power to the primary cell. In some cases, any lower transmit power may be sufficient to justify the handover, while in other cases, a value of the relative difference may need to exceed a threshold amount in order to justify the expense, in terms of power consumption, associated with processing the handover.

Thus, WCD 102 executing cell reselection module 110 is able to operate more efficiently by conserving battery 119 power through handing over a communication to a new or secondary cell, such as a femtocell, based on a lower reverse link transmit power required for communication with the new cell relative to the current or primary cell, such as a network base station.

With reference now to FIG. 2, exemplary graphs 200 for selecting one or more transfer thresholds 208, 210 for facilitating a transfer by a WCD to a secondary cell are depicted. Exemplary graphs 201, 203 and 205 depict a function 211, 213 or 215 defining a relationship between WCD current drain 206 and transmit power to a primary cell 204. Generally, as can been seen in the depicted graphs, the function 211 may be substantially linear with a relatively small slope for a portion of the graph, and thereafter the current drain 206 may increase relatively rapidly with respect to increased transmit power 204. At one or more points in this later portion of the depicted graph, a transfer threshold (e.g. first threshold 208) may be triggered. For example, such a threshold may be set by a device or component manufacturer, by a wireless network operator, or by a user of the device. For instance, such a threshold may be set a point in the function determined to be appropriate to initiate investigation of the transfer, such as but not limited to a point corresponding to relative change in the rate of power consumption. In one aspect, triggering of the first threshold 208 may prompt the WCD to locate possible available secondary cells within the vicinity of the primary cell. Additionally, or in the alternative, dynamic first threshold 210 may be used to trigger location of secondary cells. In such an aspect, dynamic first threshold 210 may vary as a function of WCD battery life 212 such that the threshold may be triggered at lower current drain 206 and transmit power 204 as the WCD battery life decreases.

In another aspect, in graph 203, estimated remaining talk time 214 as a function 213 of current drain may be interpreted to determine a first threshold. In such an aspect, as increased power is needed for the transmission signal, additional burden is placed on the WCD battery as the current drain increases, which in turn reduces battery life, which in turn reduces estimated remaining talk time 214 on a WCD. In such an aspect, talk time may be a function of aggregate transmission power.

In yet another aspect, in graph 205, reverse link data rates 216 as a function 215 of non-data channel (e.g. pilot channel, fundamental channel, etc.) transmit power 218 may be interpreted to determine a first threshold. Generally, reverse link data rates 216 may be determined by an amount of power available after power consumed by pilot, fundamental, and other non-data channels. In other words, reverse link data rates 216 may be considered dependent on a calculation of transmit power headroom for data channels. Such a calculation may be performed through subtracting the sum of the powers of non-data channels from an aggregate transmission power value. As such, reverse link data rates 216 may be estimated through analysis of headroom available in the reverse link signal. In one aspect, approximately 10 dB to 12 dB of transmission signal headroom may be needed to support transmission of data at 153.6 kbps (16×) on a reverse supplemental channel (R-SCH). Assuming a total transmission power of 23 dB, transmission powers of 11 dB to 13 dB may be used for reverse pilot signal (R-PICH) and reverse fundamental channel (R-FCH) communication before R-SCH data rates may be reduced. In one aspect, as transmission power needed for R-PICH and R-FCH increases, less headroom is available for data transmission on R-SCH. In such an aspect, reduced headroom below a first threshold triggers the WCD to locate possible secondary cells.

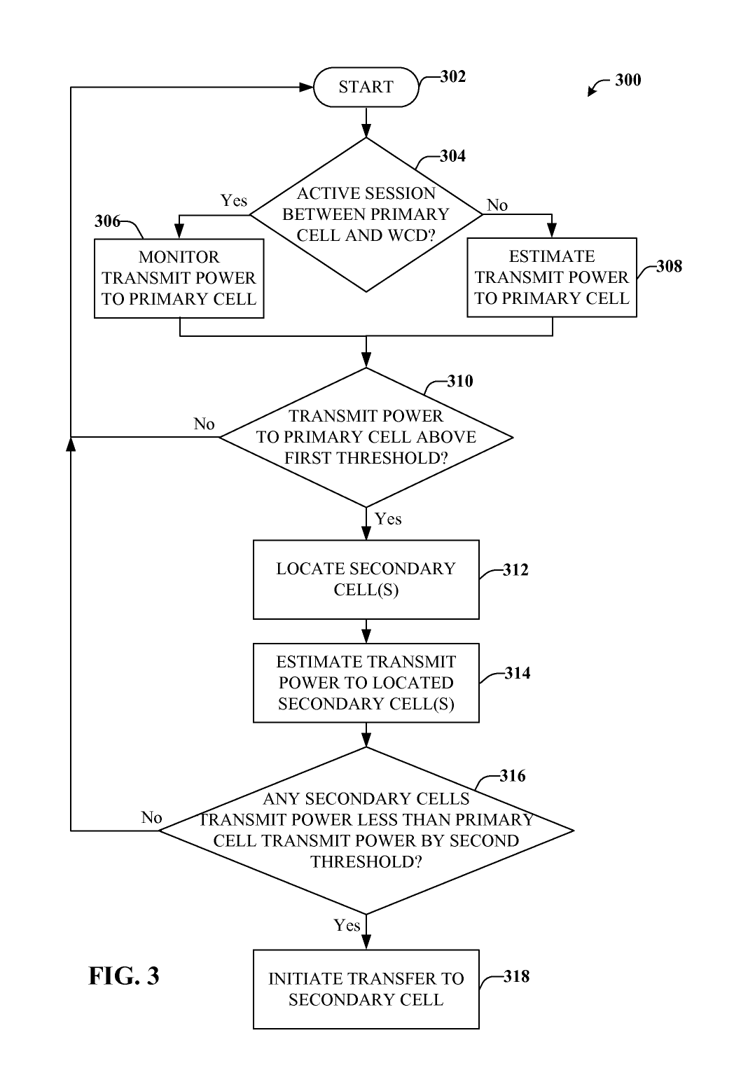

FIG. 3 illustrates various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 3, exemplary method 300 for facilitating a session transfer by a wireless communications device to a secondary cell is illustrated. Generally, at reference numeral 302, a WCD may be in communication with a primary cell. For example, WCD may have negotiated a communication session with a base station and may be actively communicating or may be in an idle mode. Next to be described, at reference numeral 304, it is determined whether the WCD is in active communication with an associated primary cell. For example, the WCD may be active by being in a traffic mode or state with the associated base station.

If at reference numeral 304, it is determined that the WCD is in active communication with the primary cell, then at reference numeral 306 transmission power to the primary cell may be monitored using an open-loop or closed-loop power control measurement. In one aspect, monitoring may be accomplished using an open-loop and/or closed-loop power control measurements. In open-loop power control measurements, a WCD transmit power is a function of the WCD received power without any direct control from a network, base station (BS), or primary cell. As such, open-loop power control estimation allows a WCD to determine transmission power based on various received information, such as but not limited to, received power from a base station transmission. Closed-loop power control measurements provide direct feedback to the WCD from the network, BS, or primary cell to control the power of the WCD. As such, closed-loop power control allows transmission power to be determined from and controlled by data received from the associated BS.

By contrast, if at reference numeral 304, it is determined that the WCD is not in active communication with the primary cell, then at reference numeral 308 transmission power to the primary cell may be monitored by estimating the transmit power to the primary cell. In one aspect, estimating, by estimator 118 for example, may be accomplished using an open-loop power control measurements.

At reference numeral 310, once the transmit power has been obtained, it is determined whether the obtained transmit power exceeds a first threshold. In one aspect, the first threshold may include one or more static and/or dynamic thresholds, such as the threshold depicted in FIG. 2. In one aspect, triggering of the first threshold may prompt the WCD to locate possible available secondary cells having a coverage area corresponding to a current position of the WCD or within the vicinity of the primary cell. For example, WCD may obtain a neighbor list including such secondary cells from base station, or WCD may listen for beacons from other cells. Additionally, or in the alternative, a dynamic first threshold may be used to trigger location of secondary cells. In such an aspect, a dynamic first threshold may vary as a function of a WCD battery life such that the threshold may be triggered at a relatively lower current drain and/or transmit power as the WCD battery life decreases.

If at reference numeral 310, it is determined that the transmit power to the primary cell does not exceed one or more first thresholds, then the process may end and/or return to reference numeral 302 to restart. In one aspect, the process may be started and/or restarted under multiple circumstances such as, upon a predetermined periodically repeating cycle, upon a user command, upon a base station command, etc.

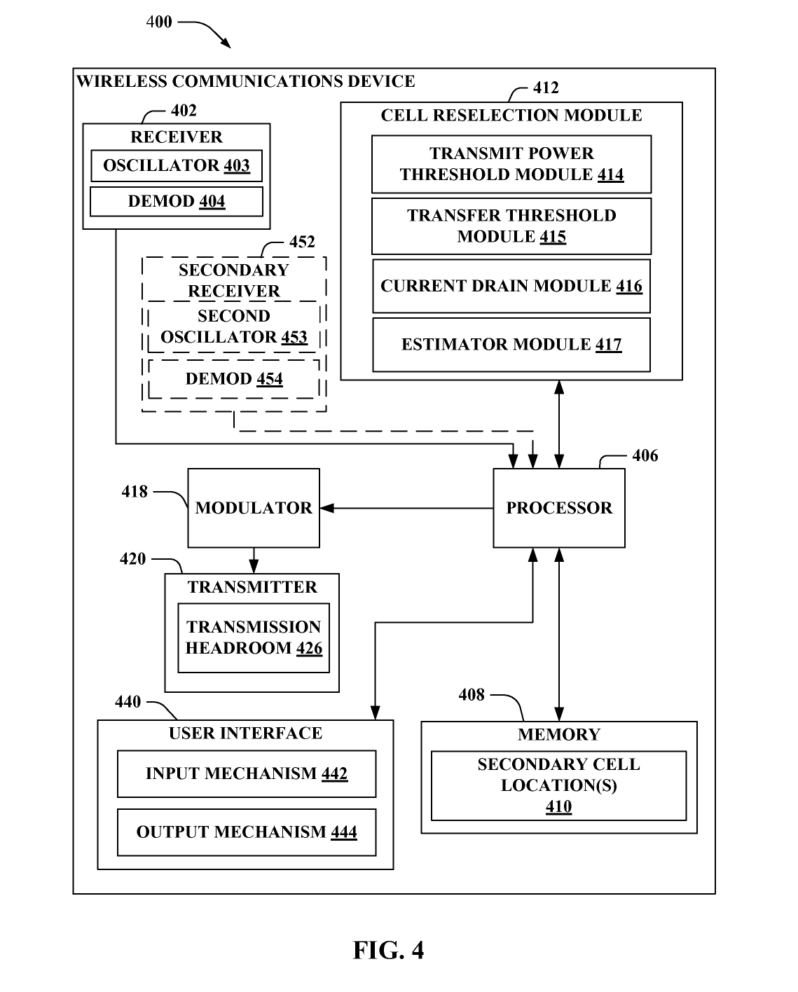

By contrast, if at reference numeral 310, it is determined that the transmit power to the primary cell has exceeded the first threshold, then at reference numeral 312, secondary cells may be located. In one aspect, when a WCD has a single receiving chain, e.g. a receiver and associated hardware and software for processing received signals, the WCD may tune away from the primary cell signal to locate the one or more secondary cell signals. In other words, the receiver may allocate different times for listening to the primary cell and one or more secondary cells. In another aspect, when a WCD has multiple receiving chains, e.g. more than one receiver and corresponding hardware and software, thereby allowing simultaneous processing of two different signals, the WCD may tune a secondary receiving chain to locate one or more secondary cell signals. Further discussion of receiving chains is presented with reference to FIG. 4. In yet another aspect, secondary cells may be located through information received through a primary cell signal, e.g. the aforementioned neighbor list or other equivalent set of information.

At reference numeral 314, transmit power to the one or more located secondary cells may be estimated. In one aspect, estimating may be accomplished by estimator 119, for example, using an open-loop power control estimate process.

At reference numeral 316, it is determined whether any of the located secondary cells have estimated transmit powers that are less than the obtained transmit power to the primary cell by a second threshold value. In one aspect, the second threshold may include at least one of: a service provider defined value, a user defined value, a dynamic value depending on the WCD battery life, multiple values in which a lower first value is used for service provider consistent transfers and a higher second value is used for transfers across service provider, or any combination thereof. In one aspect, a second threshold may be determined through analysis of frequency of transfers between cells measured over a defined time and selected to avoid transfers occurring more often than a defined frequency. As noted above, for example, the second threshold value may represent an absolute lower estimated transmit power, while in other aspect, the second threshold value may represent a minimum relative difference sufficient to justify the handover.

If at reference numeral 316, it is determined that none of the located secondary cells have estimated transmit powers that are less than the obtained transmit power to the primary cell by a second threshold value, then the process may end and/or return to reference numeral 302 to restart.

By contrast, if at reference numeral 316, it is determined that at least one of the located secondary cells has an estimated transmit power that is less than the obtained transmit power to the primary cell by a second threshold value, then at reference numeral 318 a transfer to a secondary cell may be initiated. In one aspect, a transfer from the primary cell to the secondary cell includes a hand-in from a base station to a femtocell. In another aspect, a transfer from the primary cell to the secondary cell includes a hand-out from a femtocell to a base station. Either of these two aspects may be otherwise referred to as a handover. In one aspect, the secondary cell may be selected based on one or more factors, such as but not limited to: a lowest value of estimated transmit power to the secondary cell, a maximum value of signal strength from the secondary cell, a quality of service factor, such as reverse link data rate, a lowest financial cost associated with using the secondary cell, a relative consistency of service provided between the primary and secondary cell, or any combination thereof.

Thus, a WCD executing method 300 is able to operate more efficiently by conserving battery power through handing over a communication to a new or secondary cell, such as a femtocell, based on a lower reverse link transmit power required for communication with the new cell relative to the current or primary cell, such as a network base station.

With reference now to FIG. 4, an illustration of a wireless communications device 400 (e.g. a client device) that facilitates a transfer by a wireless communications device to a secondary cell, based on reverse link transmit power, is presented. Client device 400 comprises receiver 402 that receives a signal from, for instance, a receive antenna (not shown), performs typical actions on (e.g., filters, amplifies, downconverts, etc.) the received signal, and digitizes the conditioned signal to obtain samples. Receiver 402 can comprise oscillator 403 that can provide a carrier frequency for demodulation of the received signal. Receiver 402 can comprise demodulator 404 that can demodulate received symbols and provide them to processor 406 for channel estimation. In one aspect, receiver 402 may tune away from receiving information to scan or and/or locate possible candidate secondary cells. In one aspect, receiver 402 may receive multiple receiving chains corresponding to the signal carrier frequency provided by the oscillator 403. In such an aspect, the multiple receiving chains may be considered to be “slaved” to the signal frequency.

In one aspect, client device may further comprise secondary receiver 452, second oscillator 453 to tune reception to a secondary frequency and/or channel, and secondary demodulator 454 that may receive additional channels of information. In one aspect, second oscillator 453 allows multiple, independently tunable receiving chains to be processed. For example, an oscillator 403 may be tuned to reception of a signal from a primary cell on a first frequency, while oscillator 453 may be tune to reception of a signal from a secondary cell on a second frequency. In one aspect, secondary receiver 452 may be used to locate candidate secondary cells. Additionally, in one aspect, when secondary receiver 452 is used to locate, and estimate transmission to power to, secondary cells, then a compensation factor may be added for any difference in gain between receiver 402 and secondary receiver 452.

Processor 406 can be a processor dedicated to analyzing information received by receiver 402 and/or generating information for transmission by one or more transmitters 420 (for ease of illustration, only one transmitter is shown), a processor that controls one or more components of client device 400, and/or a processor that both analyzes information received by receiver 402 and/or receiver 452, generates information for transmission by transmitter 420, and controls one or more components of client device 400. In one aspect, transmission headroom 426 may be transmitted by transmitter 420. As described above, in such an aspect, transmission headroom 426 may include transmission power available for transmission of data on R-SCH. In other words, “headroom” may be defines as a maximum possible transmission power for WCD 400 less transmission power used for pilot and/or fundamental channel communications. In one aspect, available transmission headroom 426 may be calculated by subtracting a maximum determined transmission power from the transmission power used for R-PICH and R-FCH.

Client device 400 can additionally comprise memory 408 that is operatively coupled to processor 406 and that can store data to be transmitted, received data, information related to available channels, data associated with analyzed signal and/or interference strength, information related to an assigned channel, power, rate, or the like, and any other suitable information for estimating a channel and communicating via the channel. Memory 408 can additionally store protocols and/or algorithms associated with estimating and/or utilizing a channel (e.g., performance based, capacity based, etc.). In one aspect, memory may include secondary cell location data 410. In such an aspect, secondary cell location data 410 may include information obtained from receiver 402 and/or secondary receiver 452 with respect to available candidate secondary cells in the vicinity of the WCD 400.

It will be appreciated that the data store (e.g., memory 408) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 408 of the subject systems and methods is intended to comprise, without being limited to, these and any other suitable types of memory.

Client device 400 can further comprise a cell reselection module 412 to facilitate session transfer to a secondary cell. Cell reselection module 412 may further include transmit power threshold module 414 to assist in determining when transmission power from WCD 400 to a primary cell exceeds one or more predefined thresholds. In one aspect, the first threshold may be selected by determining when a value, derived from plotting the estimated remaining talk time against the transmit power (e.g. a scope, change in slope, curve, etc.), changes above a predetermined value. Further, the first threshold may be selected by determining when a value, derived from plotting the reverse link data rate against the transmit power (e.g. a scope, change in slope, curve, etc.), changes above a predetermined value.

Cell reselection module 412 may further include transfer threshold module 415 to assist in determining whether a located secondary cell is sufficiently superior to the primary cell to merit transfers service to the secondary cell. In one aspect, the second threshold may include at least one of: a service provider defined value, a user defined value, a dynamic value depending on the WCD battery life, multiple values in which a lower first value is used for service provider consistent transfers and a higher second value is used for transfers across service provider, or any combination thereof.

Cell reselection module 412 may further include current drain module 416 to assist in monitoring the effect of transmission power on the battery life of WCD 400. In one aspect, either or both of thresholds derived from transmit power threshold module 414 and transfer threshold module 415 may dynamically change with reference to WCD 400 remaining battery life. For example, increased current drain due to increased transmission power needs may reduce WCD 400 performance parameters such as talk time and/or reverse link data rate.

Cell reselection module 412 may further include estimator module 417 to assist in determining an actual or estimated amount of power required by transmitter 420 to generate a reverse link transmission to the primary and/or secondary cell. For example, estimator 417 may use open-loop and/or closed-loop power control measurements to estimate an actual or estimated amount of power required to generate a reverse link transmission to the primary and/or secondary cell. In open-loop power control measurements, transmit power by transmitter 420 is a function of WCD 400 received power without any direct control from a network, base station (BS), or primary cell. As such, open-loop power control estimation allows WCD 400 to determine transmission power from transmitter 420 based on various received information by receiver 402, such as but not limited to, received power from a base station transmission. Closed-loop power control measurements provide direct feedback to WCD 400 from a network, BS, or primary cell to control the transmit power from transmitter 420. As such, closed-loop power control allows transmission power to be determined from and controlled by data received from an associated BS.

Additionally, mobile device 400 may include user interface 440. User interface 440 may include input mechanisms 442 for generating inputs into wireless device 400, and output mechanism 442 for generating information for consumption by the user of wireless device 400. For example, input mechanism 442 may include a mechanism such as a key or keyboard, a mouse, a touch-screen display, a microphone, etc. Further, for example, output mechanism 444 may include a display, an audio speaker, a haptic feedback mechanism, a Personal Area Network (PAN) transceiver etc. In the illustrated aspects, output mechanism 444 may include a display operable to present media content that is in image or video format or an audio speaker to present media content that is in an audio format.

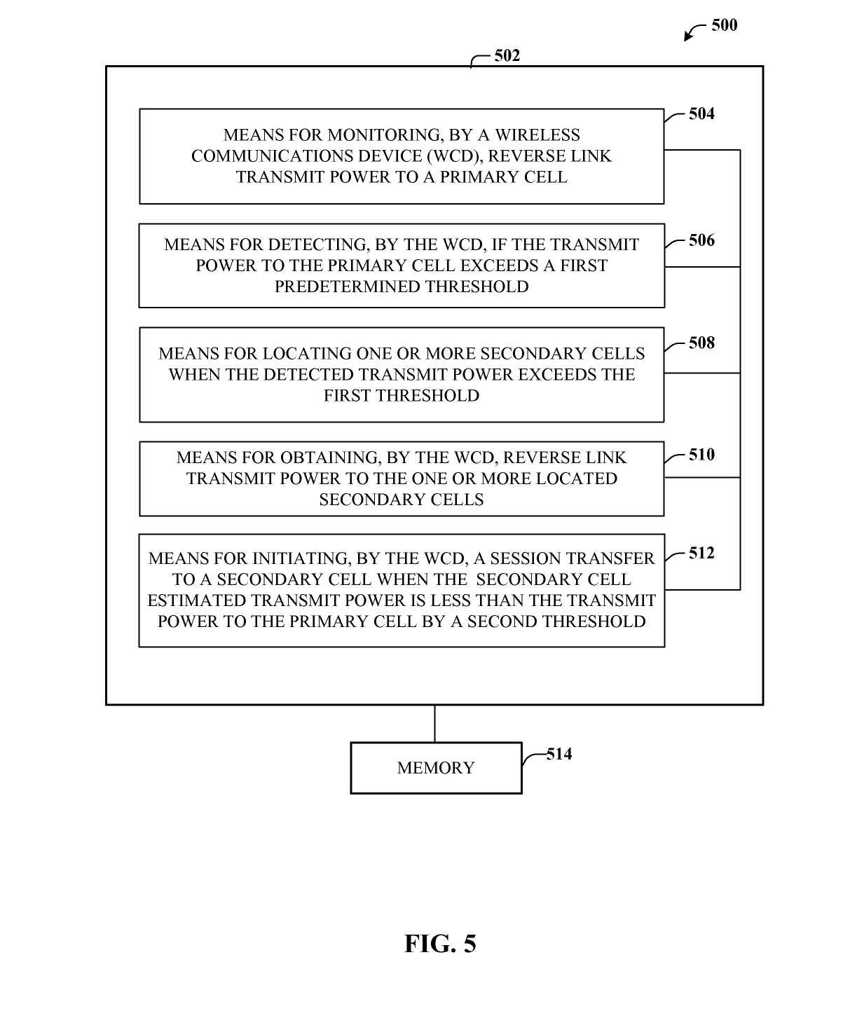

With reference to FIG. 5, illustrated is a system 500 for facilitating a session transfer by a wireless communications device to a secondary cell. For example, system 500 can reside at least partially reside within a base station, mobile device, etc. According to another example aspect, system 500 can reside at least partially within an access terminal It is to be appreciated that system 500 is represented as including functional blocks, which can be functional blocks that represent functions implemented by a processor, software, or combination thereof (e.g., firmware).

System 500 includes a logical grouping 502 of means that can act in conjunction. For instance, logical grouping 502 can include means for obtaining, by a wireless communications device (WCD), reverse link transmit power to a primary cell 504. In one aspect, when the WCD is in an idle mode, transmit power to the primary cell may be estimated. For example, an open-loop power control estimate may be used to estimate and/or monitor the reverse link transmit power to a primary cell.

Further, logical grouping 502 can comprise means for detecting, by the WCD, if the transmit power to the primary cell exceeds a first threshold 506. In one aspect, the first threshold is determined through analysis of a current drain for the WCD compared to transmit power. For example, increased current drain may reduce WCD performance parameters such as talk time and/or reverse link data rate. As such, the first threshold may be selected by determining when a value, derived from plotting the estimated remaining talk time against the transmit power (e.g. a scope, change in slope, curve, etc.), changes above a predetermined value. Further, the first threshold may be selected by determining when a value, derived from plotting the reverse link data rate against the transmit power (e.g. a scope, change in slope, curve, etc.), changes above a predetermined value. In another aspect, the first threshold may be selected to be a dynamic threshold depending on WCD battery life, wherein the dynamic threshold biases more favorably towards facilitating a transfer as the WCD battery life decreases.

Additionally, logical grouping 502 can comprise means for locating one or more secondary cells when the detected transmit power exceeds the first threshold 508. In one aspect, when a WCD has a single receiving chain, the WCD may tune away from the primary cell signal to locate the one or more secondary cell signals. In another aspect, when a WCD has multiple receiving chains, the WCD may tune a secondary receiving chain to locate one or more secondary cell signals. In another aspect, secondary cells may be located through information received from a primary cell signal. Further, logical grouping 502 can comprise means for obtaining, by the WCD, reverse link transmit power to one or more located secondary cells 510. In one aspect, the obtaining may include a WCD measuring the reverse link transmits power values. In one aspect, the obtaining may include a WCD receiving the reverse link transmits power values from a primary cell signal, and/or a signal from at least one of the one or more secondary cells. In one aspect, the obtaining may include a WCD receiving the secondary cell signals and estimating transmits powers to the one or more secondary cells from their respective received signal strengths. In another aspect, an open loop power control estimate may be used to determine secondary cell transmit power.

Further, logical grouping 502 can comprise means for initiating, by the WCD, a session transfer to a secondary cell when the secondary cell estimated transmit power is less than the transmit power to the primary cell by a second threshold 512. In one aspect, the secondary cell may be selected from the group consisting of: least estimated transmit power to the secondary cell, maximum signal strength from the secondary cell, consistent service provider between the primary and secondary cell, or any combination thereof. In one aspect, the second threshold may include at least one of: a service provider defined value, a user defined value, a dynamic value depending on the WCD battery life, multiple values in which a lower first value is used for service provider consistent transfers and a higher second value is used for transfers across service provider, or any combination thereof.

Based at least in part on this information, options for facilitating a session transfer by a wireless communications device to a secondary cell can be inferred. Additionally, system 500 can include a memory 514 that retains instructions for executing functions associated with the means 504, 506, 508, 510 and 512. While shown as being external to memory 514, it is to be understood that one or more of the means 504, 506, 508, 510 and 512 can exist within memory 514.

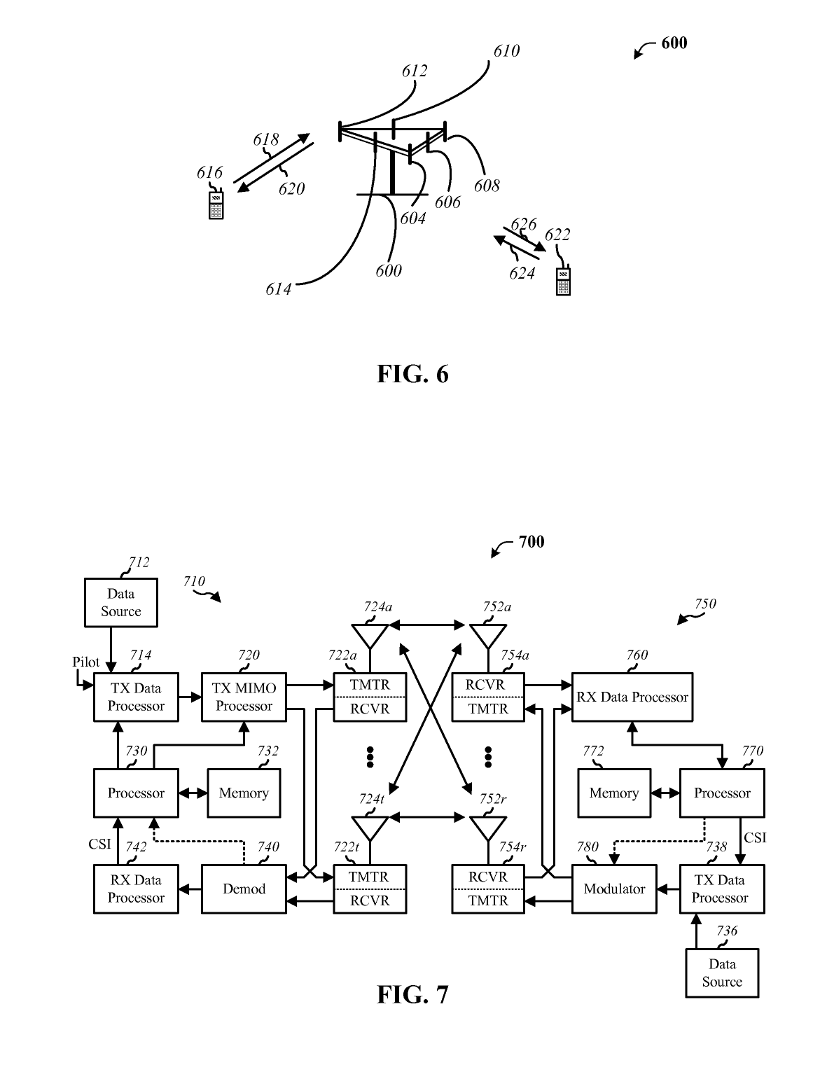

Referring to FIG. 6, a multiple access wireless communication system according to one aspect is illustrated. An access point 600 (AP) includes multiple antenna groups, one including 604 and 606, another including 608 and 610, and an additional including 612 and 614. In FIG. 6, only two antennas are shown for each antenna group, however, more or fewer antennas may be utilized for each antenna group. Access terminal 616 (AT) is in communication with antennas 612 and 614, where antennas 612 and 614 transmit information to access terminal 616 over forward link 620 and receive information from access terminal 616 over reverse link 618. Access terminal 622 is in communication with antennas 606 and 608, where antennas 606 and 608 transmit information to access terminal 622 over forward link 626 and receive information from access terminal 622 over reverse link 624. In a FDD system, communication links 618, 620, 624 and 626 may use different frequency for communication. For example, forward link 620 may use a different frequency then that used by reverse link 618.

Each group of antennas and/or the area in which they are designed to communicate is often referred to as a sector of the access point. In the aspect, antenna groups each are designed to communicate to access terminals in a sector, of the areas covered by access point 600.

In communication over forward links 620 and 626, the transmitting antennas of access point 600 utilize beamforming in order to improve the signal-to-noise ratio of forward links for the different access terminals 616 and 624. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a Node B, a femtocell or some other terminology. An access terminal may also be called user equipment (UE), a wireless communication device, terminal or some other terminology.

Referring to FIG. 7, a block diagram of an aspect of a transmitter system 710 (also known as the access point) and a receiver system 750 (also known as access terminal) in a MIMO system 700 is illustrated. At the transmitter system 710, traffic data for a number of data streams is provided from a data source 712 to a transmit (TX) data processor 714.

In an aspect, each data stream is transmitted over a respective transmit antenna. TX data processor 714 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 730.

The modulation symbols for all data streams are then provided to a TX MIMO processor 720, which may further process the modulation symbols (e.g., for OFDM). TX MIMO processor 720 then provides N_{T} modulation symbol streams to N_{T} transmitters (TMTR) 722a through 722t. In certain aspects, TX MIMO processor 720 applies beamforming weights to the symbols of the data streams and to the antenna from which the symbol is being transmitted.

Each transmitter 722 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 722a through 722t are then transmitted from N_{T} antennas 724a through 724t, respectively.

At receiver system 750, the transmitted modulated signals are received by N_{R} antennas 752a through 752r and the received signal from each antenna 752 is provided to a respective receiver (RCVR) 754a through 754r. Each receiver 754 conditions (e.g., filters, amplifies, and downconverts) a respective received signal, digitizes the conditioned signal to provide samples, and further processes the samples to provide a corresponding “received” symbol stream.

An RX data processor 760 then receives and processes the N_{R} received symbol streams from N_{R} receivers 754 based on a particular receiver processing technique to provide N_{T} “detected” symbol streams. The RX data processor 760 then demodulates, deinterleaves, and decodes each detected symbol stream to recover the traffic data for the data stream. The processing by RX data processor 760 is complementary to that performed by TX MIMO processor 720 and TX data processor 714 at transmitter system 710.

A processor 770 periodically determines which pre-coding matrix to use (discussed below). Processor 770 formulates a reverse link message comprising a matrix index portion and a rank value portion.

The reverse link message may comprise various types of information regarding the communication link and/or the received data stream. The reverse link message is then processed by a TX data processor 738, which also receives traffic data for a number of data streams from a data source 736, modulated by a modulator 780, conditioned by transmitters 754a through 754r, and transmitted back to transmitter system 710.

At transmitter system 710, the modulated signals from receiver system 750 are received by antennas 724, conditioned by receivers 722, demodulated by a demodulator 740, and processed by a RX data processor 742 to extract the reserve link message transmitted by the receiver system 750. Processor 730 then determines which pre-coding matrix to use for determining the beamforming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In an aspect, Logical Traffic Channels comprises a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), a Uplink Shared Data Channel (UL-SDCH) and plurality of PHY channels. The PHY channels comprise a set of DL channels and UL channels.

The DL PHY channels may comprise:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprises:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations may apply:

AM Acknowledged Mode

AMD Acknowledged Mode Data

ARQ Automatic Repeat Request

BCCH Broadcast Control Channel

BCH Broadcast Channel

C- Control-

CCCH Common Control Channel

CCH Control Channel

CCTrCH Coded Composite Transport Channel

CP Cyclic Prefix

CRC Cyclic Redundancy Check

CTCH Common Traffic Channel

DCCH Dedicated Control Channel

DCH Dedicated Channel

DL DownLink

DSCH Downlink Shared Channel

DTCH Dedicated Traffic Channel

FACH Forward link Access Channel

FDD Frequency Division Duplex

L1 Layer 1 (physical layer)

L2 Layer 4 (data link layer)

L3 Layer 4 (network layer)

LI Length Indicator

LSB Least Significant Bit

MAC Medium Access Control

MBMS Multimedia Broadcast Multicast Service

MCCHMBMS point-to-multipoint Control Channel

MRW Move Receiving Window

MSB Most Significant Bit

MSCH MBMS point-to-multipoint Scheduling Channel

MTCH MBMS point-to-multipoint Traffic Channel

PCCH Paging Control Channel

PCH Paging CHannel

PDU Protocol Data Unit

PHY Physical layer

PhyCHPhysical Channels

RACH Random Access Channel

RLC Radio Link Control

RRC Radio Resource Control

SAP Service Access Point

SDU Service Data Unit

SHCCH Shared channel Control Channel

SN Sequence Number

SUFI Super Field

TCH Traffic Channel

TDD Time Division Duplex

TFI Transport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN multicast broadcast single frequency network

MCE MBMS coordinating entity

MCH multicast channel

DL-SCH downlink shared channel

MSCH MBMS control channel

PDCCH physical downlink control channel

PDSCH physical downlink shared channel

Further, for example, the present aspects may be applied to a Long Term Evolution (LTE) system, including components such as: an Evolved NodeB (E-NodeB), which has base station functionality; an Evolved UMTS Terrestrial Radio Access Network (E-UTRAN), which is the network that includes the E-NodeBs; and an Evolved Packet Core (EPC), also known as a System Architecture Evolution (SAE) core, which serves as the equivalent of GPRS networks via the Mobility Management Entity (MME), Serving Gateway (S-GW) and Packet Data Node (PDN) Gateway subcomponents.

The MME is a control-node for the LTE access-network. It is responsible for idle mode UE tracking and paging procedure including retransmissions. It is involved in the bearer activation/deactivation process and is also responsible for choosing the SGW for a UE at the initial attach and at time of intra-LTE handover involving Core Network (CN) node relocation. It is responsible for authenticating the user (by interacting with the HSS). The Non-Access Stratum (NAS) signaling terminates at the MME and it is also responsible for generation and allocation of temporary identities to UEs. It checks the authorization of the UE to camp on the service provider's Public Land Mobile Network (PLMN) and enforces UE roaming restrictions. The MME is the termination point in the network for ciphering/integrity protection for NAS signaling and handles the security key management. Lawful interception of signaling is also supported by the MME. The MME also provides the control plane function for mobility between LTE and 4G/3G access networks with the S3 interface terminating at the MME from the SGSN. The MME also terminates the S6a interface towards the home HSS for roaming UEs.

The SGW routes and forwards user data packets, while also acting as the mobility anchor for the user plane during inter-E-NodeB handovers and as the anchor for mobility between LTE and other 3GPP technologies (terminating S4 interface and relaying the traffic between 4G/3G systems and PDN GW). For idle state UEs, the SGW terminates the DL data path and triggers paging when DL data arrives for the UE. It manages and stores UE contexts, e.g. parameters of the IP bearer service, network internal routing information. It also performs replication of the user traffic in case of lawful interception.

The PDN GW provides connectivity to the UE to external packet data networks by being the point of exit and entry of traffic for the UE. A UE may have simultaneous connectivity with more than one PDN GW for accessing multiple PDNs. The PDN GW performs policy enforcement, packet filtering for each user, charging support, lawful Interception and packet screening. Another role of the PDN GW is to act as the anchor for mobility between 3GPP and non-3GPP technologies such as WiMAX and 3GPP2 (CDMA 1X and EvDO).

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 4” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for facilitating a session transfer by a wireless communications device to a secondary cell, the method comprising:
obtaining, by a wireless communications device (WCD), reverse link transmit power to a primary cell;
detecting, by the WCD, if the transmit power to the primary cell exceeds a first threshold;
locating one or more secondary cells when the detected transmit power exceeds the first threshold;
obtaining, by the WCD, reverse link transmit power to the one or more located secondary cells; and
initiating, by the WCD, a session transfer to a secondary cell when the secondary cell estimated transmit power is less than the transmit power to the primary cell by a second threshold.

2. The method of claim 1, wherein the primary cell is a macro-cell, the secondary cell is a femtocell, and wherein the session transfer includes a hand-in from the macro-cell to the femtocell.

3. The method of claim 1, wherein the primary cell is a femtocell, the secondary cell is a macro-cell, and wherein the session transfer includes a hand-out from the femtocell to the macro-cell.

4. The method of claim 1, wherein the obtaining reverse link transmit power to a primary cell further includes:
estimating the transmit power to the primary cell when the WCD is in an idle mode.

5. The method of claim 4, wherein the estimating transmit power for the primary cell further includes using an open loop power control estimate.

6. The method of claim 1, wherein the first threshold is determined through analysis of a current drain for the WCD compared to transmit power.

7. The method of claim 6, wherein the current drain is further analyzed as it applies to estimated remaining talk time for the WCD, and wherein the first threshold is selected by determining when a derived value changes above a set value, wherein the derived value is derived from a function comparing an estimated remaining talk time against the transmit power.

8. The method of claim 6, wherein the current drain is further analyzed as it applies to reverse link data rate for the WCD, and wherein the first threshold is selected by determining when a derived value changes above a set value, wherein the derived value is derived from a function comparing a reverse link data rate against a non-data transmit power portion of the transmit power.

9. The method of claim 1, wherein the first threshold is selected to be a dynamic threshold depending on WCD battery life, wherein the dynamic threshold biases more favorably towards facilitating a transfer as the WCD battery life decreases.

10. The method of claim 1, wherein the WCD has a single receiving chain and wherein the locating further includes tuning away from a primary cell signal to locate one or more secondary cell signals.

11. The method of claim 1, wherein the WCD has multiple receiving chains and wherein the locating further includes tuning a secondary receiving chain of the multiple receiving chains to locate the one or more secondary cell signals.

12. The method of claim 1, wherein the locating further includes receiving information from the primary cell providing possible available secondary cells within the vicinity of the primary cell.

13. The method of claim 1, wherein the obtaining reverse link transmit power to the one or more located secondary cells further includes:
receiving one or more located secondary cell signals each having a respective signal strength; and
calculating estimated transmit power to the one or more secondary cells from the respective signal strength of the one or more received secondary cell signals.

14. The method of claim 1, wherein the obtaining, by the WCD, reverse link transmit power to the one or more located secondary cells further includes using an open loop power control estimate.

15. The method of claim 1, wherein the secondary cell is selected based on one or more of the following factors: a value of the estimated transmit power to the secondary cell, a value of the signal strength from the secondary cell, a quality of service value, a financial cost of using the secondary cell, consistent service provider between the primary and secondary cell, or any combination thereof.

16. The method of claim 1, wherein the second threshold may include at least one of: a service provider defined value, a user defined value, a dynamic value depending on the WCD battery life, multiple values in which a lower first value is used for service provider consistent transfers and a higher second value is used for transfers across service provider, or any combination thereof.

17. At least one processor configured for making calls from a wireless communications device in a source country outside of a home country:
a first module for obtaining, by a wireless communications device (WCD), reverse link transmit power to a primary cell;
a second module for detecting, by the WCD, if the transmit power to the primary cell exceeds a first threshold;
a third module for locating one or more secondary cells when the detected transmit power exceeds the first threshold;
a fourth module for obtaining, by the WCD, reverse link transmit power to the one or more located secondary cells; and
a fifth module for initiating, by the WCD, a session transfer to a secondary cell when the secondary cell estimated transmit power is less than the transmit power to the primary cell by a second threshold.

18. A computer program product, comprising:
a computer-readable medium comprising:
a first set of codes for causing a computer to obtain, by a wireless communications device (WCD), reverse link transmit power to a primary cell;
a second set of codes for causing the computer to detect, by the WCD, if the transmit power to the primary cell exceeds a first threshold;
a third set of codes for causing the computer to locate one or more secondary cells when the detected transmit power exceeds the first threshold;
a fourth set of codes for causing the computer to obtain, by the WCD, reverse link transmit power to the one or more located secondary cells; and
a fifth set of codes for causing the computer to initiate, by the WCD, a session transfer to a secondary cell when the secondary cell estimated transmit power is less than the transmit power to the primary cell by a second threshold.

19. An apparatus, comprising:
means for obtaining, by a wireless communications device (WCD), reverse link transmit power to a primary cell;
means for detecting, by the WCD, if the transmit power to the primary cell exceeds a first threshold;
means for locating one or more secondary cells when the detected transmit power exceeds the first threshold;
means for obtaining, by the WCD, reverse link transmit power to the one or more located secondary cells; and
means for initiating, by the WCD, a session transfer to a secondary cell when the secondary cell estimated transmit power is less than the transmit power to the primary cell by a second threshold.

20. A wireless communication device, comprising:
a cell reselection module operable for:
obtaining reverse link transmit power to a primary cell; and
detecting if the transmit power to the primary cell exceeds a first threshold;
a receiver operable for locating one or more secondary cells when the detected transmit power exceeds the first threshold; and
wherein the cell reselection module is further operable for:
obtaining, by the WCD, reverse link transmit power to the one or more located secondary cells; and
initiating, by the WCD, a session transfer to a secondary cell when the secondary cell estimated transmit power is less than the transmit power to the primary cell by a second threshold.

21. The apparatus of claim 20, wherein the primary cell is a macro-cell, the secondary cell is a femtocell, and wherein the session transfer includes a hand-in from the macro-cell to the femtocell.

22. The apparatus of claim 20, wherein the primary cell is a femtocell, the secondary cell is a macro-cell, and wherein the session transfer includes a hand-out from the femtocell to the macro-cell.

23. The apparatus of claim 20, wherein the cell reselection module is further operable for estimating the transmit power to the primary cell when the WCD is in an idle mode.

24. The apparatus of claim 23, wherein the cell reselection module is further operable for estimating transmit power for the primary cell using an open loop power control estimate.

25. The apparatus of claim 20, wherein the first threshold is determined through analysis of current drain for the WCD compared to the transmit power.

26. The apparatus of claim 25, wherein the cell reselection module is further operable for analyzing an estimated remaining talk time for the WCD, and wherein the first threshold is selected by determining when a derived value changes above a set value, wherein the derived value is derived from a function comparing an estimated remaining talk time against the transmit power.

27. The apparatus of claim 25, wherein the cell reselection module is further operable for analyzing a reverse link data rate for the WCD, and wherein the first threshold is selected by determining when a derived value changes above a set value, wherein the derived value is derived from a function comparing a reverse link data rate against a non-data transmit power portion of the transmit power.

28. The apparatus of claim 20, wherein the first threshold is selected to be a dynamic threshold depending on WCD battery life, wherein the dynamic threshold biases more favorably towards facilitating a transfer as the WCD battery life decreases.

29. The apparatus of claim 20, wherein the receiver is further operable for including a single receiving chain and wherein the single receiving chain is operable for tuning away from a primary cell signal to locate one or more secondary cell signals.

30. The apparatus of claim 20, wherein the receiver is further operable for including multiple receiving chains and wherein the receiver is further operable for tuning a secondary receiving chain of the multiple receiving chains to locate the one or more secondary cell signals.

31. The apparatus of claim 20, wherein the receiver is further operable for receiving information from the primary cell providing possible available secondary cells within the vicinity of the primary cell.

32. The apparatus of claim 20, wherein the cell reselection module is further operable for:
receiving one or more located secondary cell signals each having a respective signal strength; and
calculating estimated transmit power to the one or more secondary cells from the respective signal strength of the one or more received secondary cell signals.

33. The apparatus of claim 20, wherein the cell reselection module is further operable for obtaining reverse link transmit power to the one or more located secondary cells using an open loop power control estimate.

34. The apparatus of claim 20, wherein the secondary cell is based on one or more of the following factors: a value of the estimated transmit power to the secondary cell, a value of the signal strength from the secondary cell, a financial cost of using the secondary cell, a value of a quality of service factor, consistent service provider between the primary and secondary cell, or any combination thereof.

35. The apparatus of claim 20, wherein the second threshold may include at least one of: a service provider defined value, a user defined value, a dynamic value depending on the WCD battery life, multiple values in which a lower first value is used for service provider consistent transfers and a higher second value is used for transfers across service provider, or any combination thereof.
